(19) United States
(12) Patent Application Publication
(10) Pub. No.: US 2006/0162228 A1
(43) Pub. Date: Jul. 27, 2006

(54) Lineless waterfowl anchor with throwing capability

(76) Inventor: Robert Sieman, Amherst, NY (US)

Correspondence Address: PATRICIA M. COSTANZO;PATS PENDING, P.O. BOX 101, ELMA, NY, 14059, US

(21) Appl. No.: 11/155,696

(22) Filed: Jun. 17, 2005

Related U.S. Application Data
(60) Provisional application No. 60/647,120, filed on Jan. 26, 2005.

(51) Int. Cl. A01M 31/06

(52) U.S. Cl. 43/3

(57) ABSTRACT

A lineless anchor weight assembly attachable to a floating object and method for making, comprising a rigid rod permanently attached to an environmentally safe, hermetically encapsulated, solid lead weight. The impermeable encapsulate may be of a polyvinylchloride. The rod may be of a fiberglass or of a naturally-occurring material exhibiting rigidity. The floating object may be a decoy, such as a puddle duck decoy with a keel having a receiver aperture for receiving the anchor weight attachment means. One end of the attachment may be a connector means for fastening the attachment means to the floatable object and may also be attached to the rod. Alternatively, if the decoy has a receiver aperture above the keel, the anchor weight attachment means further comprises an adapter to provide for such attachment. The assembly is for anchoring, throwing, and retrieving a decoy eliminating any problems due to tangling.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE OR A COMPUTER PROGRAM LISTING COMPACT DISK APPENDIX

Not Applicable

### BACKGROUND

The present invention relates generally to anchors for floating objects and more particularly to an environmentally safe anchor having no lines or cords to tangle.

The background information discussed below is presented to better illustrate the novelty and usefulness of the present invention. This background information is not admitted prior art.

It is common for hunters when hunting water fowl such as ducks and geese to place decoys on the water to encourage ducks and geese flying overhead to land. The two major classes of ducks hunted are puddle ducks and diving ducks. Puddle ducks, also referred to as dipping, surface-feeding, pond, river, or freshwater ducks are physically and behaviorally different from diving ducks. Physically, puddle ducks differ from diving ducks, in that puddle ducks have unlobed hind feet that are also smaller than the hind feet of diving ducks. This accounts for the fact that puddle ducks rarely dive for their food and, therefore, are most often found feeding in shallow water. Puddle ducks mainly feed on water plants that they obtain by tipping tail-end up in shallow water. In addition to eating water plants, puddle ducks often forage near shore for seeds and insects.

The use of decoys when hunting the shallow water puddle ducks, such as mallards, black ducks, mottled ducks, Mexican ducks, pintails, gadwalls, American wigeons, shovelers, wood ducks, green-winged teal, blue-winged teal, cinnamon teal, fulvous tree duck, black-bellied tree ducks, and American coots presents a special set of problems for the decoy setter.

A typical puddle duck decoy mimics the shape and color of the shallow water ducks and often is equipped with a weighted keel mounted lengthwise along the decoy's bottom centerline to help maintain the stability of the decoy as it floats on the shallow surface part of a lake, stream, or marsh pond. In order for the decoys to remain in a desired position, the decoys often rely on weights to anchor the decoy on the bottom of the lake, stream, or marsh pond. The weight helps to keep the decoy relatively stationary against the effects of wind or water movement that may be caused by changes in the tide level or by a river current. Whenever the decoy has a keel, a length of line is tied to a tying aperture in the keel and the weight. Presently available decoy anchors are generally made of lead, because of its high specific gravity, although some are made of other metals. Lead, of course, is well known to cause serious pollution, especially when exposed to water. If the weight is made of a different metal, one that is not as polluting as lead, the metal is likely to be adversely affected by the environment. Steel or iron decoy anchors are subject to corrosion during use and storage and become unsightly if not maintained by painting. The paint, however, may also be a pollutant. It would, thus, be desirable to provide a decoy anchor which is attractive in appearance, requires little or no maintenance, is non-polluting, and is easily and compactly storable with the decoy.

The puddle duck decoys presently available pose several additional problems that all are caused by the tangling of the line or cord that is used to attach the decoy to the weight. Most hunters use several decoys at one time to better simulate natural conditions, and before hunting commences, the decoy set must be retrieved from storage and transported to the hunting site. Often, the decoys are stored and transported in a large sack. When the decoys are being transported, a hunter will wrap each decoy's line and attached weights around the decoy's neck several times to avoid tangling. But as there is no way to fasten the lines, they and the weights often come loose and become entangled. While carrying the decoys to the hunting site, the loose weights may knock against the decoys scratching the decoy paint and making a noise that can scare off the birds being hunted.

Once the decoys are brought to the hunting site, they must be placed in the water. A realistic looking, well-place decoy spread entices more ducks to take a closer look at the decoy spread. Proper placement of the decoys results in fewer decoys being needed to attract ducks, especially when hunting puddle ducks, as puddle ducks, especially early in the hunting season, usually are in smaller groups than diver ducks, and, thus, require fewer decoys to get their attention. If the hunter can attract ducks using fewer decoys, the hunter can be more mobile because he or she has fewer decoys to put out and take down every time there is a change in hunting location. Increased mobility equals more opportunity to shot more ducks. Throwing the decoys to create a properly place decoy spread, however, is not a straightforward effort. Working with decoys that are presently available means that each decoy has to set by itself to avoid tangling the lines even before the decoys are in the water. And, once in the water it is difficult to place the decoys so that their lines do not become tangled either with each other or with the ubiquitous water plants present in the areas where puddle ducks are found. Moreover, retrieving the decoys means retrieving each decoy separately or else the lines once again would become tangled. Setting and retrieving decoys is a time and energy consuming process. For ages, waterfowl hunters have tried to solve the problem of tangled decoy lines. It would be most advantageous to hunters to have decoys that would not become tangled with other decoys or with plant life during storage, transport, throwing, floating, and retrieval. Hunters would especially appreciate a means for throwing and retrieving a set of decoys all at the same time, thus saving them time that could be used for hunting.

Several attempts have been made to address the problem of tangled decoy lines. One such attempt teaches a waterfowl decoy anchor that is typically secured to the decoy by tying a first end of an anchor connecting line to an anchor line receiving aperture in the decoy's keel. Attached to a second end of the connecting line is a first end of a latex cord, which is attached to an anchor ball of lead or other metal. The anchor ball is sealed up to the tubing with vinyl plastic or rubber, helping to avoid water pollution by lead and corrosion of the ball if made of a metal other than lead. The connecting cord and anchor are wound around the keel for storage. This attempt does nothing to prevent line tangling while the decoy is being thrown in the water, or being retrieved, and only minimally discourages tangling when the decoys are being transported or are in storage.

A similar effort to minimize tangling a decoy that when not in use has the anchor line coiled around the decoy and thereafter the strap coiled about the decoy's neck. Then, the anchor is positioned over the bill of the decoy. Decoys with this anchoring system should not become entangled when in storage or being transported to the hunting site. However, the tangling problems that arise when the decoys are thrown in the water, or upon retrieval, are still there.

Another similar effort teaches a decoy having an anchor line that is to be wound about the decoy's stabilizing fin (keel) on the bottom of the decoy and retained in place by a hook while being transported. This prevents the tangling of decoy weights and rope while the decoys are being transported to and from the hunting site, but again tangling while the decoys are being set in the water and being retrieved is not prevented.

There is even a bird decoy for attracting predators, for hunting or photographing, that may be supported on a rod or other support means. This decoy is not a floatable decoy and is not designed for use as a puddle duck decoy. The rod to which the decoy is attached is provided for being inserted into the ground, on land or at the bottom of a shallow water body. This rod is not structurally capable of being attached to an anchor.

It is clear then that none of the above discussed attempts, taken either singly or in combination, has succeeded in providing for a decoy anchor that is attractive in appearance, requires little or no maintenance, is non-polluting, is easily and compactly storable with the decoy and that would not become tangled with other decoys or with plant life during storage, transport, throwing, floating, and retrieval. Hunters would also appreciate a means for throwing and retrieving a set of decoys all at the same time, thus saving them from minutes to hours.

### SUMMARY

The present invention satisfies the current unmet need for an improved lineless, anchor device that is attractive in appearance, requires little or no maintenance, is non-polluting and environmentally safe. When the anchor of the present invention is used in conjunction with a decoy, such as a puddle duck decoy, it is easily and compactly storable even when attached to the decoy. Importantly, the lineless anchor will not become tangled with other lineless decoys nor is it likely to become tangled with plant life that grows in the water. Moreover, the lineless anchor according to the principles of the present invention will not become tangled during storage, transport, throwing, floating, and retrieval. Furthermore, the lineless anchor provides means for throwing and retrieving a set of decoys, all at the same time, thus saving hunters from minutes to hours in preparation time, as well as saving similar amounts of time at the end of the hunt when the decoys must be retrieved, transported, and put away in storage. The lineless anchor device of the present invention is ideal for use in flooded fields, swamps, or any open water shallows.

The lineless anchor of the present invention has solved the problems of tangling decoy lines by eliminating the need for lines. The decoy anchor according to the principles of the present invention utilizes a solid rod molded directly to a lead weight. Lead pollution concerns are eliminated by placing the weight in a watertight, sealed encapsulant.

The decoy anchor as taught herein provides for many advantages in addition to providing an attractive, non-polluting weight for use with puddle duck decoys. In addition to anchoring the decoys, the anchor provides for a handle to carry the decoys attached to the decoy anchor to and from the hunting site. Because the rigid-like anchor rods cannot become tangled, all of the decoys may be carried to and from the site simultaneously.

Once the site is reached, instead of having to set each decoy individually, several, or all, of the decoys may be thrown at the same time without the worry of line tangling. Prior concerns of having lines wrapping about the decoys and tangling with one another has been eliminated. Once the decoys have been placed in the water the anchor weight, molded onto the rod, settles to the bottom of the water body to hold the decoys in place.

When hunting is finished for the day, the decoys are lifted from the water using the encapsulated anchor weight as a comfortable and functional carrying handle. All of the decoys may be carried at the same time, again without fear of having lines tangled. Multiple trips to and from the water to retrieve each decoy are eliminated. This saves valuable time, as well as eliminating frustration when setting up the decoy spread and when bringing the decoys in at the end of the day.

The present invention also provides for efficient storage and transport of the decoys with or without the lineless anchor weights attached to the decoys. After retrieving all of the decoys, the lineless anchor weights may be left attached to the decoys for easy placement of the decoys, even if the lineless anchors are left attached to the decoys, into the decoy bag and for easy retrieval of the decoys/anchors from the bag. If desired, however, the lineless anchors may be rapidly detached from the decoys simply by opening the heavy duty clasp that is part of each of the attachment means of the lineless anchor device.

Moreover, that lineless anchor device of the present invention provides for its attachment directly to the anchor line receiving hole that is present in the keel of most duck decoys. The decoy anchor device of the present invention also provides for the attachment of the device to those decoys that have their anchor attachment receiver hole above the keel by providing for adapters.

The present invention supplies all of these benefits and more by providing for:

A lineless anchor weight assembly, comprising:

a) a rod of a desired length having a functional amount of rigidity and having a first end and a second end;

b) an attachment means having a first end and a second end, wherein the second end of the attachment means is attached to the first end of the rod, and

c) an anchor weight means attached to the second end of the rod, wherein the first end of the attachment means provides for attachment of the lineless anchor weight assembly to a floatable object to maintain the object in a desired position while floating.

In a preferred embodiment the anchor weight means is made of lead, and in a more preferred embodiment the anchor weight means is made using molten lead providing for the rod to be permanently encased into a first end of the anchor weight means,

Following the principles of the present invention, the anchor weight means is impermeably sealed prohibiting the anchor weight means from interacting with the environment providing for the anchor assembly to be environment compatible.

In the favored embodiment, it is further contemplated that the anchor weight means is impermeably sealed using a synthetic organic polymer, wherein the synthetic organic polymer may be a polyvinylchloride.

Another favored embodiment contemplates wherein the rod is made from a synthetic organic polymer, wherein the synthetic organic polymer may be a fiberglass. Alternatively, the rod is made of a naturally-occurring material that can exhibit rigidity.

Yet still, another favored embodiment contemplates wherein the floating object is a duck decoy, that may be a puddle duck decoy that further comprises a keel wherein the keel further comprises a receiver aperture functionally adapted for receiving the anchor weight attachment means.

An additional favored embodiment provides for:

a) one end of the attachment means to further comprise an optional flexible fastener providing for fastening the attachment means to the rod, and

b) a second end of the attachment means to further comprise a connector means for fastening the attachment means to the floatable object that may, optionally attach to the rod.

Furthermore, it is contemplated wherein the lineless anchor weight assembly attachment means is functionally attachable to the puddle duck decoy having a keel with a receiver aperture functionally adapted for receiving the anchor weight attachment means.

Alternatively, it is contemplated wherein the puddle duck decoy comprises a receiver aperture positioned above the keel, where the receiver aperture is functionally adapted for receiving the anchor weight attachment means.

Moreover, the anchor weight attachment means further comprises an adapter providing for the anchor weight to attach to the puddle duck decoy having a receiver aperture positioned above the keel.

It is also contemplated where one of the favored embodiments provides for the anchor weight means rod to further comprise:

a) a first end operatively fitted with an end capping means, and

b) a second end is operatively fitted with an end capping means having an optional flange for securing the anchor weight to a bottom of a water body.

The invention also provides for a method for making a lineless anchor weight assembly, comprising the steps of:

a) providing for a rod of a desired length with the rod having a first end and a second end;

b) providing for an attachment means having a first end and a second end;

c) attaching the second end of the attachment means to the first end of the rod;

d) providing for an anchor weight means;

e) attaching the anchor weight means to the second end of the rod,

wherein the first end of the attachment means provides for attachment of the lineless anchor weight assembly to a floatable object to maintain the object in a desired position while floating.

Still other benefits and advantages of this invention will become apparent to those skilled in the art upon reading and understanding the following detailed specification and related drawings.

### BRIEF DESCRIPTION OF THE DRAWINGS

In order that these and other objects, features, and advantages of the present invention may be more fully comprehended and appreciated, the invention will now be described, by way of example, with reference to specific embodiments thereof which are illustrated in appended drawings wherein like reference characters indicate like parts throughout the several figures. It should be understood that these drawings only depict preferred embodiments of the present invention and are not therefore to be considered limiting in scope, thus, the invention will be described and explained with additional specificity and detail through the use of the accompanying drawings, in which:

FIG. 1 is a partial perspective view illustrating a decoy set for use in a shallow body of water with the lineless anchor weight assembly of the present invention attached to the decoy.

FIG. 2 is an enlarged sectional planar view of the decoy with the lineless anchor weight assembly of the present invention, as shown in FIG. 1, for better illustrating the means used to attach the lineless anchor weight assembly to a decoy using a receiver hole that is situated in the keel.

FIG. 2a is an enlarged sectional planar view of a decoy with the lineless anchor weight assembly of the present invention similar to the decoy as shown in FIG. 1 but different in that the receiver hole is above the keel of the decoy.

FIG. 3a is a perspective view illustrating the anchor weight of this invention with the open end of the encapsulating means ready to receive the molten lead that provides for the weight.

FIG. 3b is a perspective view illustrating the anchor weight of this invention after the molten lead that was poured into the encapsulating means has set with an end cap providing a secure seal over the previously open end of the encapsulation means.

### A LIST OF THE REFERENCE NUMBERS AND PARTS OF THE INVENTION TO WHICH NUMBERS REFER

2 Puddle duck decoy with receiver hole 6 in keel 4.
2a Puddle duck decoy with receiver hole 6a in keel 4a.
4 Keel of duck decoy 2 with receiver hole 6 in keel.
4a Keel of duck decoy 2 with receiver hole 6 in keel.
6 Receiver hole of keel 4 for receiving anchor weight attachment means 14.
6a Receiver hole above keel 4a for receiving anchor weight attachment means 14.
8 Lineless anchor weight assembly.
10 Puddle duck decoy set for use in a shallow body of water with weight of the present invention attached to the decoy.
12 Rod which is fairly rigid and molded to the anchor weight is the main part of the anchor assembly connecting weight to decoy.
14 Attachment means which in the illustrative example could be a wire or a cord, but may be a ring or the like, for attaching rod 12 to connector means 16.
16 Connector means 16 attaching attachment means 14 to keel 4 by means of receiver hole 6.
18 Anchor weight.
20 Adapter.
22 Endcap.
24a Aperture.
24b Aperture.
26 Solid lead core of anchor weight 18.
28 Stabilizing means for stabilizing rod until molten lead solidifies.
30 Encapsulation means for encapsulating solid lead core 26 of anchor weight 18.
32a End cap.
32b End cap with optional flange.
40 Open end through which molten lead is poured.
   Definitions
Keel, as used herein, refers to any weight attached to the bottom of a floating device to prevent the device from being tipped over, as from being tipped over by the wind.
Receiver aperture, as used herein, refers to any opening, hole, or aperture designed for the attachment of something, which in this case is a flexible attachment means such as a cord, a wire, or the like.
Rod, as used herein, refers to any length of any relatively rigid length of material, such as a fishing pole rod or a broom handle, wherein the length is operatively sufficient to allow for the rod to extend from its attachment point to a floatable object to the bottom of the water body upon which the floatable object is floating.

It should be understood that the drawings are not necessarily to scale. In certain instances, details which are not necessary for an understanding of the present invention or which render other details difficult to perceive may have been omitted.

### DETAILED DESCRIPTION

Referring now, with more particularity, to the drawings, it should be noted that the disclosed invention is disposed to embodiments in various sizes, shapes, and forms. Therefore, the embodiments described herein are provided with the understanding that the present disclosure is intended as illustrative and is not intended to limit the invention to the embodiments described herein.

The present invention is directed towards a lineless, anchor weight assembly that is attachable to a floating object and to a method for making the assembly. The lineless anchor weight assembly comprises a rigid rod permanently attached to an environmentally safe, hermetically encapsulated, solid lead weight. The impermeable encapsulate may be made of a synthetic organic polymer, such as a polyvinylchloride. The rod may be made of a synthetic organic polymer, such as a fiberglass, or of a naturally-occurring material exhibiting rigidity. In a favored embodiment, the floating object may be a decoy, such as a puddle duck decoy with a keel having a receiver aperture for receiving the anchor weight attachment or connector means. One end of the attachment may be a snap means, such as a coast lock snap for fastening the attachment or connector means to the floatable object. The attachment or connector means may be attached directly to the rod, or there may be an additional attachment means between the attachment or connector means and the rod, as desired. Alternatively, if the decoy has its receiver aperture positioned above the keel, the anchor weight attachment means further comprises an optional adapter to provide for such attachment. While eliminating problems due to tangling, the assembly of the present invention provides for anchoring, throwing, and retrieving floating objects such as decoys.

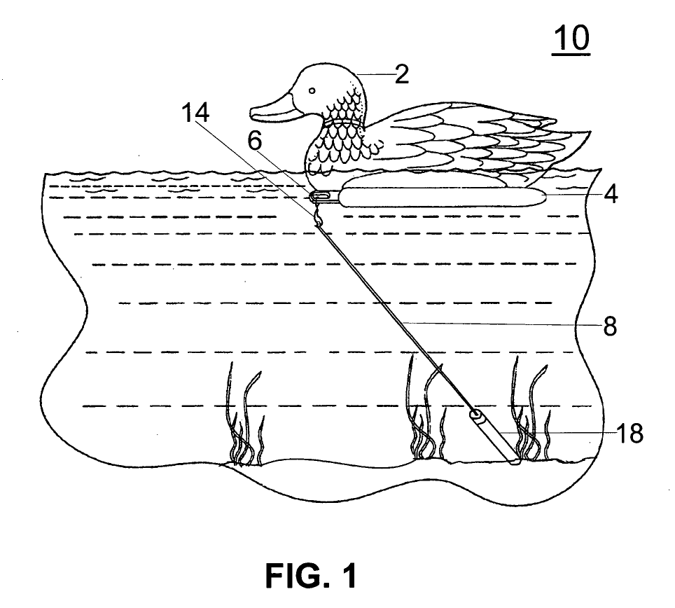

Turning now to the drawings, FIG. 1, a partial perspective view, illustrates lineless anchor weight assembly 8 attached to a floating object according to the principles of the present invention. Puddle duck decoy 2 is used herein for illustration purposes, although it is to be understood that the lineless anchor weight assembly may be used with any other type of floating device, such as a buoy or a marker for instance. In particular, FIG. 1 shows the decoy with attached lineless anchor weight assembly set for use in a shallow body of water. Decoy 2 is shown having receiver hole 6 positioned in keel 4. Lineless anchor weight assembly 8 comprises rod 12, anchor weight 18, and attachment means 14. Attachment means 14 attaches lineless anchor weight assembly 8 to decoy 2 using receiver hole 6. Rod 12 has a required functional amount of rigidity. The rigid rod of a desired length eliminates the need for a line that tangles. Thus, rod 12 eliminates the tangling problems presented by flexible lines by eliminating the flexible line.

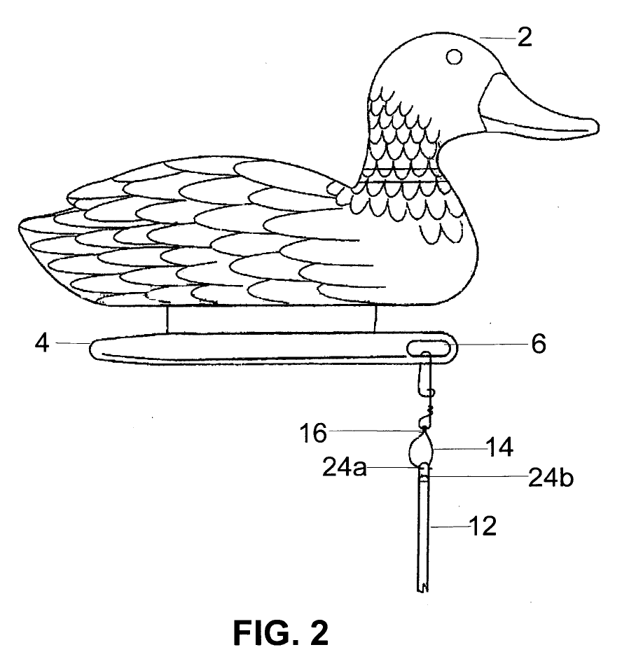

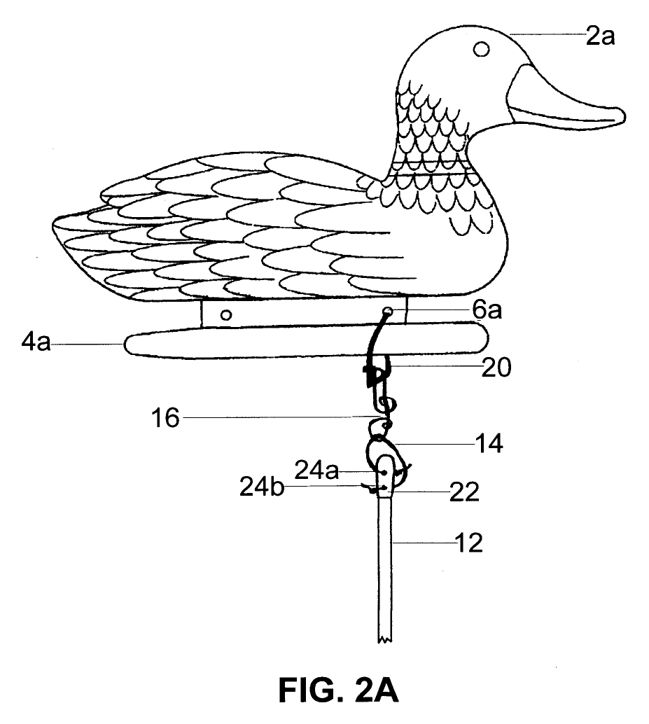

FIG. 2, an enlarged sectional planar view of the decoy and the attachment means of lineless anchor weight assembly of the present invention, is presented to illustrate one example of means that may be used to attach the lineless anchor weight assembly to a floating object, such as to decoy 2. In the example shown, a first end of connector means 16 is attached to decoy 2 using receiver aperture 6, which is functionally situated in keel 4. For illustrative purposes, connector means 16 may be a snap, such as a coast lock snap, a swivel snap, or any other functional connector. Attached to a second end of connector means 16 is a first end of optional attachment means 14, which in this example is a wire, cord, ring, or the like. A second end of attachment means 14 is attached to a first end of rod 12 through aperture 24a. If desired, only one part of the attachment means illustrated may be used. For example, connector means 16 may be configured to be attached directly to the aperture in rod 12. When used with a typical duck decoy, it is recommended for connector means 16 to have strength capable of handling the torque that is created when the decoy with the lineless anchor weight assembly attached is deployed by throwing. Those with ordinary skill in the art are familiar with the multitude of attachment means that may be used to attach the lineless anchor assembly to a floating object and thus, these need not be discussed any further here.

FIG. 2a, an enlarged sectional planar view similar to the view presented in FIG. 1, but different in that the receiver hole, used to receive the attachment means of the lineless anchor weight assembly, is positioned above the keel of the decoy. In this example, a first end of connector means 16 is attached to adapter 20 which in turn is attached to receiver aperture 6a which is functionally situated in keel 4a of decoy 2a. Now, in the same manner as is illustrated in FIG. 2 a second end of connector means 16 is attached to a first end of attachment means 14, which in this example is shown as a wire or a cord, but may be a ring or the like. A second end of attachment means 14 is attached to a first end of rod 12 through apertures 24a and 24b. As mentioned above, when used with a typical duck decoy, it is recommended for connector means 16 to have a strength capable of handling the torque that is created when the decoy with the lineless anchor weight assembly attached is deployed by throwing.

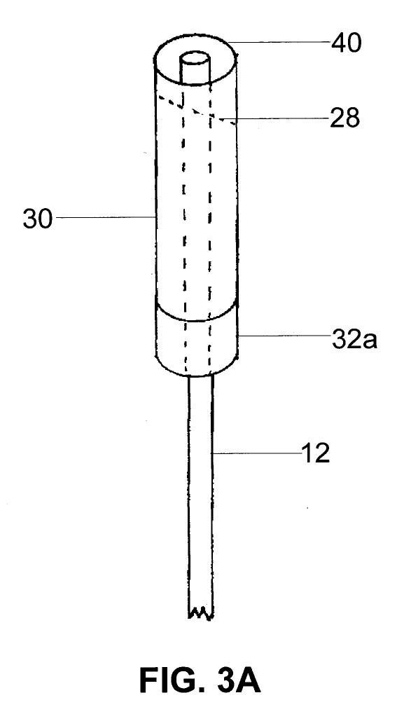

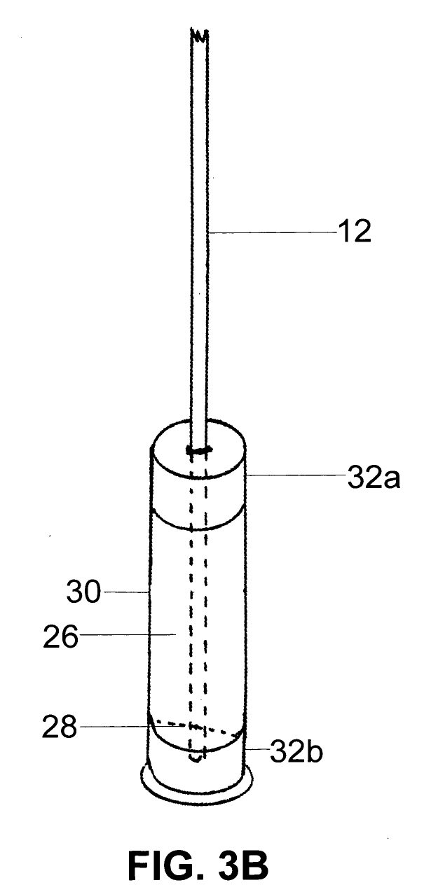

FIG. 3A, a perspective view, illustrates the tubular encapsulating weight container 30 ready for molten lead to be poured into its, as yet, open end 40. In this example, encapsulating weight container 30 is formed from polyvinylchloride to which the molten lead will bond as it hardens inside container 30. The end of container 30 opposite its open end is a closed end which is shown capped by end cap 32a. Rod 12 is shown positioned in the center of encapsulating means 30 and protrudes through end cap 32a, which can be seen in FIG. 3B. The opening in end cap 32a through which rod 12 protrudes is thoroughly sealed to prevent the environment from coming into any contact with the lead inside of encapsulating means 30. To avoid the displacement of rod 12 away from it centered position during the pouring of the molten lead, rod 12 is collared by metal support collar 28.

FIG. 3b, another perspective view of the anchor weight of this invention, illustrates anchor weight 18 after the molten lead that was poured into the encapsulating means has set with end cap 32b providing a secure seal over the previously open end of the encapsulation means. Capping means 32b is sealed over the open end to complete the encapsulation of the lead providing for a heavy lead weight to be safely used in salt or fresh water. In the example provided in FIG. 3b, capping means 32b is shown having a flanged end. The flange, as it gets caught on the mud at the bottom of the water body, provides extra stability for the weight. The flange is optional and may be provided in any number of constructions, such as having finger like struts that will add gripping power to the weight. At this point the desired attachment means for attaching the lineless weight assembly to a floating object are attached to a first end of rod 12 and the assembly is ready for use.

In a preferred embodiment, rod 12 is made from a synthetic organic polymer, such as fiberglass. Alternatively, the rod is made of a naturally-occurring material that can exhibit the rigidity required to eliminate any problems from tangling. In the example shown, rod 12 is contemplated to be solid for added strength. Additionally, rod 12 is contemplated to be lightweight for ease of handling and carrying. The rod may be of any desired length, with the depth of the body of water where the hunting will occurs being a deciding factor.

To use the lineless anchor weight assembly it is first attached to a floatable object or objects, such as a puddle duck decoy or a set of decoys using the attachment means provided with the lineless anchor weight assembly that provide for attachment of the assembly to the attachment means provided on the floatable object. Even is an entire set of objects are to be used, the entire set may be lifted at the same time by grabbing the rods or the handles (i.e., the weights) of the entire set. The set may then be placed into a decoy bag for transport to a hunting site. At the site, the set of decoys with the attached weights may be removed from the decoy bag ensemble. The decoys may then be thrown into position by grabbing the weight that functions also as a handle for throwing the decoy. The decoys may be thrown individually or in groups, as there are no lines to tangle. When the hunt is finished, the decoys may be easily retrieved and placed into the decoy bag with the anchor assemblies still attached to the decoys for transport and storage without the problems of tangling that are inherent in presently available weights with lines. Alternatively, if desired, the anchor assemblies may be easily and rapidly removed from the decoys by opening the heavy duty clasp of the assembly. Once the decoys hit the water, the weight that is molded into the assembly drops to the water's bottom and holds the decoys in place,

Thus it has been shown that the present invention has eliminated all of the problems of tangling and pollution presented by presently available decoys that all offer elastic and/or flexible lines to attach a metal weight to a decoy. The foregoing description, for purposes of explanation, uses specific and defined nomenclature to provide a thorough understanding of the invention. However, it will be apparent to one skilled in the art that the specific details are not required in order to practice the invention. Thus, the foregoing description of the specific embodiment is presented for purposes of illustration and description and is not intended to be exhaustive or to limit the invention to the precise form disclosed. Those skilled in the art will recognize that many changes may be made to the features, embodiments, and methods of making the embodiments of the invention described herein without departing from the spirit and scope of the invention. Furthermore, the present invention is not limited to the described methods, embodiments, features or combinations of features but include all the variation, methods, modifications, and combinations of features within the scope of the appended claims. The invention is limited only by the claims.

What is claimed is:

1. A lineless anchor weight assembly, comprising:
a) a rod of a desired length, said rod having a first end and a second end;
b) an attachment means having a first end and a second end, wherein said second end of said attachment means is attached to said first end of said rod, and
c) an anchor weight means attached to said second end of said rod,
wherein said first end of said attachment means provides for attachment of said anchor weight assembly to a floatable object to maintain the object in a desired position while floating.

2. The lineless anchor weight assembly, as recited in claim 1, further comprising wherein said anchor weight means is made of lead.

3. The lineless anchor weight assembly, as recited in claim 2, further comprising wherein said anchor weight means made of lead is made using molten lead,

4. The lineless anchor weight assembly, as recited in claim 1, further comprising wherein said rod is permanently encased into a first end of said anchor weight means,

5. The lineless anchor weight assembly, as recited in claim 1, further comprising wherein said anchor weight means is impermeably sealed prohibiting said anchor weight means from interacting with the environment.

6. The lineless anchor weight assembly, as recited in claim 5, further comprising wherein said anchor weight means is impermeably sealed prohibiting using a synthetic organic polymer.

7. The lineless anchor weight assembly, as recited in claim 6, further comprising wherein said synthetic organic polymer is a polyvinylchloride.

8. The lineless anchor weight assembly, as recited in claim 1, further comprising wherein said rod is made from a synthetic organic polymer.

9. The lineless anchor weight assembly, as recited in claim 8, further comprising wherein said synthetic organic polymer is a fiberglass.

10. The lineless anchor weight assembly, as recited in claim 1, further comprising wherein said rod is made from a naturally-occurring material that can exhibit rigidity.

11. The lineless anchor weight assembly, as recited in claim 1, further comprising wherein said floating object is a decoy.

12. The lineless anchor weight assembly, as recited in claim 11, wherein said decoy further comprises being a puddle duck decoy.

13. The lineless anchor weight assembly, as recited in claim 12, wherein said puddle duck decoy further comprises a keel.

14. The lineless anchor weight assembly, as recited in claim 13, wherein said keel further comprises a receiver aperture functionally adapted for receiving said anchor weight attachment means.

15. The lineless anchor weight assembly, as recited in claim 1, wherein:
a) said one end of said attachment means further comprises an optional flexible fastener providing for fastening said attachment means to said rod, and
b) said second end of said attachment means further comprises a connector means for fastening said attachment means to said floatable object and may, optionally attach to said rod.

16. The lineless anchor weight assembly, as recited in claim 14, further comprising wherein said lineless anchor weight assembly attachment means is functionally attachable to said puddle duck decoy having a keel with a receiver aperture functionally adapted for receiving said anchor weight attachment means.

17. The lineless anchor weight assembly, as recited in claim 13, wherein said puddle duck decoy further comprises a receiver aperture positioned above said keel, said receiver aperture functionally adapted for receiving said anchor weight attachment means.

18. The lineless anchor weight assembly, as recited in claim 17, wherein said anchor weight attachment means further comprises an adapter providing for said anchor weight to attach to said puddle duck decoy having a receiver aperture positioned above said keel, said receiver aperture functionally adapted for receiving said anchor weight attachment means.

19. The lineless anchor weight assembly, as recited in claim 1, further comprising wherein said anchor weight means rod further comprises:
a) said first end operatively fitted with an end capping means, and
b) a second end is operatively fitted with an end capping means having an optional flange for securing said anchor weight to a bottom of a water body.

20. A method for making a lineless anchor weight assembly, comprising the steps of:
a) providing for a rod of a desired length, said rod having a first end and a second end;
b) providing for an attachment means having a first end and a second end;
c) attaching said second end of said attachment means to said first end of said rod;
d) providing for an anchor weight means;
e) attaching said anchor weight means to said second end of said rod,
wherein said first end of said attachment means provides for attachment of said lineless anchor weight assembly to a floatable object to maintain the object in a desired position while floating.
